(19) United States
(12) Patent Application Publication
(10) Pub. No.: US 2012/0047700 A1
(43) Pub. Date: Mar. 1, 2012

(54) CASKET SYSTEM

(76) Inventors: Dean A. Kelly, Bonita Springs, FL (US); Tony C. Fifer, Angola, IN (US); Troy T. Hantz, Angola, IN (US); Larry C. Fifer, Orland, IN (US); Randy S. Smith, Waterloo, IN (US)

(21) Appl. No.: 12/868,841

(22) Filed: Aug. 26, 2010

(51) Int. Cl. A61G 17/007; A61G 99/00

(52) U.S. Cl. 27/2; 27/21.1

(57) ABSTRACT

A casket system includes: a container configured for holding a body, the container including a bottom wall; and a cardboard bed positioned within the container and configured for being that on which the body at least partially lies, the cardboard bed being selectively positionable between a first position and a second position within the container, the first position being oriented substantially horizontally and substantially parallel relative to the bottom wall, the second position being one of a plurality of selectively inclined positions relative to the bottom wall.

### BACKGROUND OF THE INVENTION

1. Field of the Invention

The present invention relates to caskets, and, more particularly, to casket beds.

2. Description of the Related Art

Caskets are often used to hold the body of a deceased human being for viewing in a dignified manner prior to burial or cremation. Such caskets may be a wooden or metallic casket. A wooden or metallic casket is known which includes a metallic bed therein which is used to raise the body to facilitate better viewing of the body within the wooden or metallic casket. A lifting arrangement is used to lift the metallic bed. This lifting arrangement includes a threaded metallic rod, a support which is attached to the wooden or metallic casket and includes a through-hole through which the rod extends, and a crank assembly including a hand crank and a hexagon-shaped piece which attaches to the rod to rotate the rod and thereby to lift and lower the metallic bed. The rod cannot be removed from the through-hole in the support because the threads are too wide.

A corrugated cardboard casket is known which holds the body of a deceased human being. Such a corrugated cardboard casket can be used as a cremation box.

What is needed in the art is a casket system which includes a cardboard bed.

### SUMMARY OF THE INVENTION

The present invention provides a casket system which includes a cardboard bed.

The invention in one form is directed to a casket system which includes: a container configured for holding a body, the container including a bottom wall; and a cardboard bed positioned within the container and configured for being that on which the body at least partially lies, the cardboard bed being selectively positionable between a first position and a second position within the container, the first position being oriented substantially horizontally and substantially parallel relative to the bottom wall, the second position being one of a plurality of selectively inclined positions relative to the bottom wall.

The invention in another form is directed to a casket system which includes: a container configured for holding a body, the container including a bottom wall; a cardboard bed positioned within the container and configured for being that on which the body at least partially lies and for being at least partially lifted off of the bottom wall while the cardboard bed remains in the container.

The invention in yet another form is directed to a method of lifting a body associated with a casket system, the method including: providing a container holding the body, the container including a bottom wall; positioning a cardboard bed within the container, the body lying at least partially on the cardboard bed; positioning selectively the cardboard bed between a first position and a second position within the container, the first position being oriented substantially horizontally and substantially parallel relative to the bottom wall, the second position being one of a plurality of selectively inclined positions relative to the bottom wall.

An advantage of the present invention is that it provides a cardboard bed for a casket system.

Another advantage is that it provides a clamp to be used in conjunction with a lifting device and the cardboard bed.

Yet another advantage is that it provides a guide block which is wooden.

Yet another advantage is that the clamp is made of plastic and thereby can be burned along with the cardboard casket, the cardboard bed, the guide block, the remains of the deceased, and optionally a plastic rod of the lifting device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of the casket system according to the present invention;

FIG. 2 is a perspective view of the casket system of FIG. 1, with portions broken away;

FIG. 3 is an exploded, perspective view of the casket system of FIG. 2, with portions broken away;

FIG. 4 is a side view of the casket system of FIG. 2, with a side wall of the container, along with the end panels of the side wall, broken away;

FIG. 5 is a top view of the cardboard bed and the clamp of FIG. 1, the clamp being slid onto the cardboard bed;

FIG. 6 is a top view of the cardboard bed and the clamp of FIG. 5, the clamp completely slid onto the cardboard bed, with portions broken away;

FIG. 7 is a perspective view of the clamp of FIG. 1 slid onto the cardboard bed, which has portions broken away; and

FIG. 8 is an end view of the cardboard bed of FIG. 5.

Corresponding reference characters indicate corresponding parts throughout the several views. The exemplifications set out herein illustrate one embodiment of the invention, and such exemplifications are not to be construed as limiting the scope of the invention in any manner.

### DETAILED DESCRIPTION OF THE INVENTION

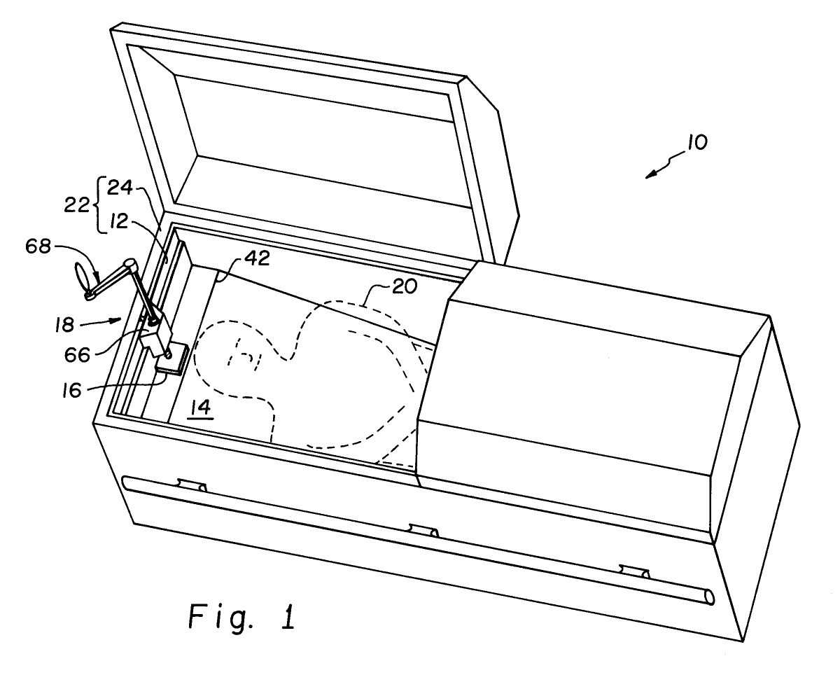

Referring now to the drawings, and more particularly to FIG. 1, there is shown a casket system 10 which generally includes a container 12, a cardboard bed 14, a clamp 16, and a lifting device 18. Casket system 10 is configured for holding and lifting or tilting a body 20, such as a human body; unless otherwise stated, the description herein refers, merely by way of example, to the body 20 of a human being who is deceased. FIG. 1 shows body 20 in broken lines.

As used herein in reference to the present invention, “cardboard” can be understood to mean: (a) “a good quality of chemical pulp or rag pasteboard which is made by combining two or more webs of paper, either with or without paste, while still wet; used for signs, printed material, and high-quality boxes” (McGraw-Hill Dictionary of Scientific and Technical Terms, Fifth Edition, New York, 1994, p. 313); (b) generically a heavy-duty paper and refer to corrugated fiberboard (a combination of paperboards, usually two flat liners and one inner fluted corrugated medium, often used for making corrugated boxes) or paperboard; (c) a material similar to thick, stiff paper, that is made of pressed paper pulp or pasted sheets of paper; or (d) a thin, stiff pasteboard. The embodiments below refer to cardboard as a corrugated structure.

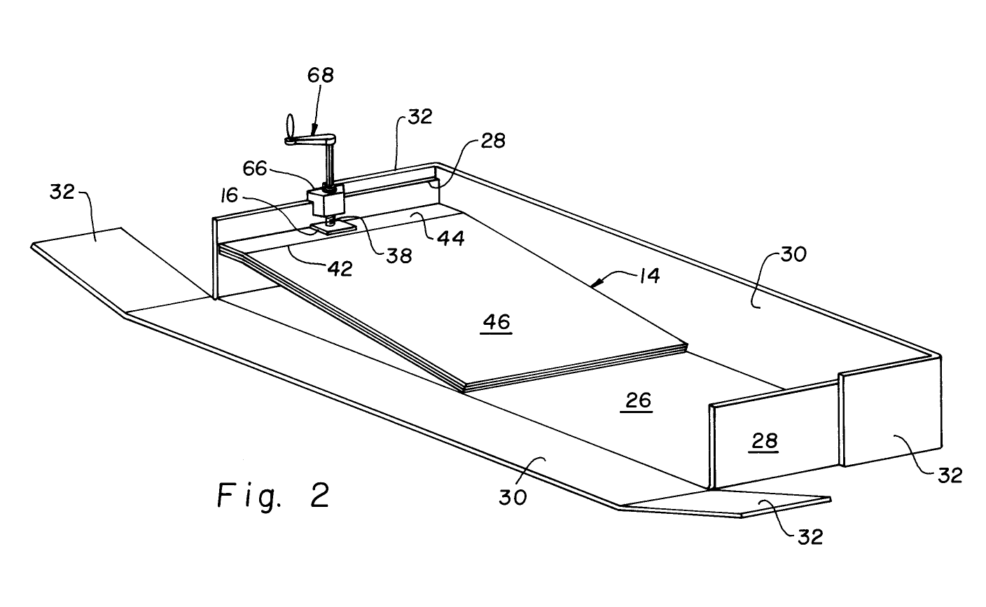

The container 12 of the present invention is configured for holding body 20. According to one embodiment of the casket system 10 of the present invention, casket system 10 includes a casket assembly 22 including an exterior casket 24 (such as a metal or wooden casket, for example) and an interior cardboard casket 12 (with bed 14 inside casket shell 12) which is nested within exterior casket 24. Such an interior cardboard casket 12 can be referred to as a casket shell. In this embodiment, the container 12 of the present invention is the interior cardboard casket 12. Cardboard casket 12 can be made of cardboard and can be used as a burial casket (for example, when exterior casket 24 is used for viewing but not burial) or, alternatively, as a cremation casket. As a burial casket, cardboard casket 12 can be used to bury a human body 20. As a cremation casket, cardboard casket 12 can be used to hold and transport a human body 20 prior to cremation. Further, as a cremation casket, cardboard casket 12 can be used to hold the body 20 during cremation; thus, cardboard casket 12, in part or in whole, can be consumed by combustion during cremation. FIG. 1 shows this embodiment of the casket system 10 of the present invention (FIGS. 2-8 omit showing exterior casket 24). According to another embodiment of the casket system of the present invention, the casket system omits exterior casket 24 but includes cardboard casket 12 as described above. FIGS. 2-4 show cardboard casket 12 apart from exterior casket 24. An example of cardboard casket 12 is disclosed in U.S. patent application Ser. No. 12/248,243.

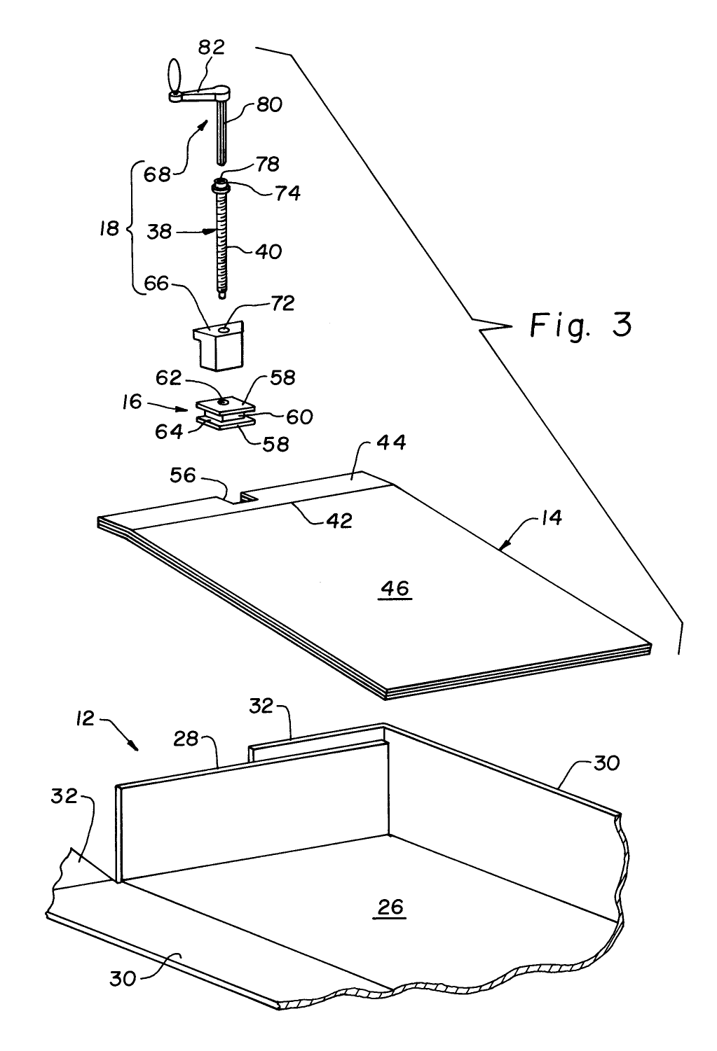

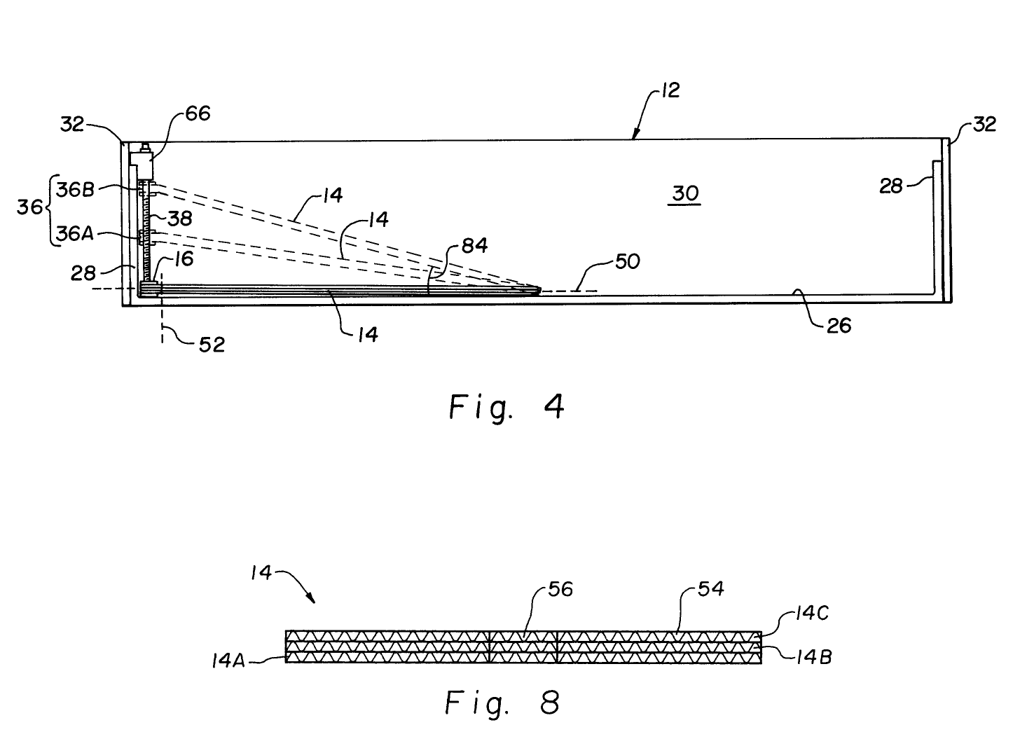

Container 12 can thus be a cardboard casket 12. FIGS. 1-4 show cardboard casket 12. Cardboard casket 12 is made of cardboard, is formed as a tub (i.e., a tub having four upstanding walls 28, 30 which are coupled to one another and which are also coupled to a bottom wall 26, but having an open top), and is configured for holding body 20. Cardboard casket 12 includes a bottom wall 26, end walls 28, and side walls 30. In one embodiment of shell 12, each side wall 30 can include two end panels 32, each end panel 32 being folded to the outside of a respective end wall 28 when end walls 28 and side walls 30 are in their upright positions; each end panel 32 can be attached to the outside of the respective end wall 28 using, for example, an adhesive, a mechanical fastener, a tie wrap or wire, and/or a hook-and-loop fastener (i.e., VELCRO®); further, adhesive can be disposed in the four corners of shell 12 (i.e., the tub 12) to further secure end walls 28 to side walls 30. Cardboard casket 12 can be held loosely within or affixed to exterior casket 24. FIG. 4 shows cardboard casket 12 with one side wall 30, along with its two end panels 32, removed from FIG. 4 for ease of viewing; the side wall 30 that is removed is the side wall that is to the right of body 20 (the body's right) in FIG. 1.

Cardboard bed 14 (which can simply be referred to as a bed 14) is made of cardboard. Cardboard bed 14 does not include any metal. Cardboard bed 14 is positioned within container 12 (cardboard casket 12, for instance). Cardboard bed 14 is configured for being that on which body 20 at least partially lies and for being at least partially lifted off of bottom wall 26 while cardboard bed 14 remains in container 12 (cardboard casket 12, for instance). Bed 14 can extend the full length of cardboard casket 12 or only partially along the full length of cardboard casket 12; FIGS. 2-4 show bed 14 having a length which extends only partially along the full length of cardboard casket 12. Cardboard bed 14 is selectively positionable between a first position 34 and a second position 36 within container 12 (cardboard casket 12, for instance). First position 34 is oriented substantially horizontally and substantially parallel relative to bottom wall 26. Stated another way, in the first position 34, cardboard bed 14 lies at least substantially flat on bottom wall 26. “Substantially” is intended to cover the situations where bed 14 lies completely flat on bottom wall 26 or is inclined slightly relative to bottom wall 26 (as shown in FIG. 4) considering that clamp 16—when clamp 16 is positioned on bottom wall 26—can cause a portion of bed 14 to be lifted slightly off of bottom wall 26. In the first position 34, clamp 16 need not have a rod 38 of lifting device 18 yet attached to clamp 16 (but clamp 16 can be attached to rod 38 in first position 34). Second position 36 is one of a plurality of selectively inclined positions (such as second positions 36A and 36B) relative to bottom wall 26. Thus, second position 36 can be a plurality of positions 36A, 36B (which does not include the first position 34), each of the positions 36A, 36B associated with second position 36 providing that at least a portion of cardboard bed 14 is tilted relative to bottom wall 26. FIG. 4 shows cardboard bed 14 in solid lines in the first position 34 and further shows cardboard bed 14 in two different second positions 36A and 36B, one of the second positions 36 being labeled as 36A, the other of the second positions 36 being labeled as 36B. Each of the positions 36A and 36 B are shown in broken lines in FIG. 4. Considering the lifting device 18 (which can also be referred to as a jack 18) that is described below, the various second positions 36 essentially form a continuum such that the operator of the lifting device 18 can stop the movement up or down of cardboard bed 14 at any point above the first position 34 along a threaded portion 40 of rod 38 and cardboard bed 14 would then occupy the second position 36. Alternatively, the lifting device 18 can be designed such that each second position 36 is a predetermined position.

Further, according to one embodiment of the cardboard bed 14 according to the present invention, cardboard bed 14 includes a plurality of layers 14A, 14B, . . . 14x of cardboard pieces which are layered atop one another. An adhesive (glue) is used to join adjacent layers of bed 14 to one another. Stated another way, cardboard bed 14 includes a plurality of layers 14A, 14B, . . . 14x attached respectively to one another. For a three-layer cardboard bed 14, for example, the bottom layer 14A is glued to the middle layer 14B, and the middle layer 14B is glued to the top layer 14C. Each layer of bed 14 can be substantially identical to one another. If, for instance, body 20 is expected to be relatively light in weight, the present invention contemplates that a single layer of cardboard could be used to form bed 14, rather than a plurality of layers. The discussion herein, however, refers to a bed 14 formed of a plurality of layers (two or more layers 14A, 14B, . . . 14x). In one embodiment of the present invention, bed 14 includes three layers 14A, 14B, 14C, as shown in FIGS. 2-4.

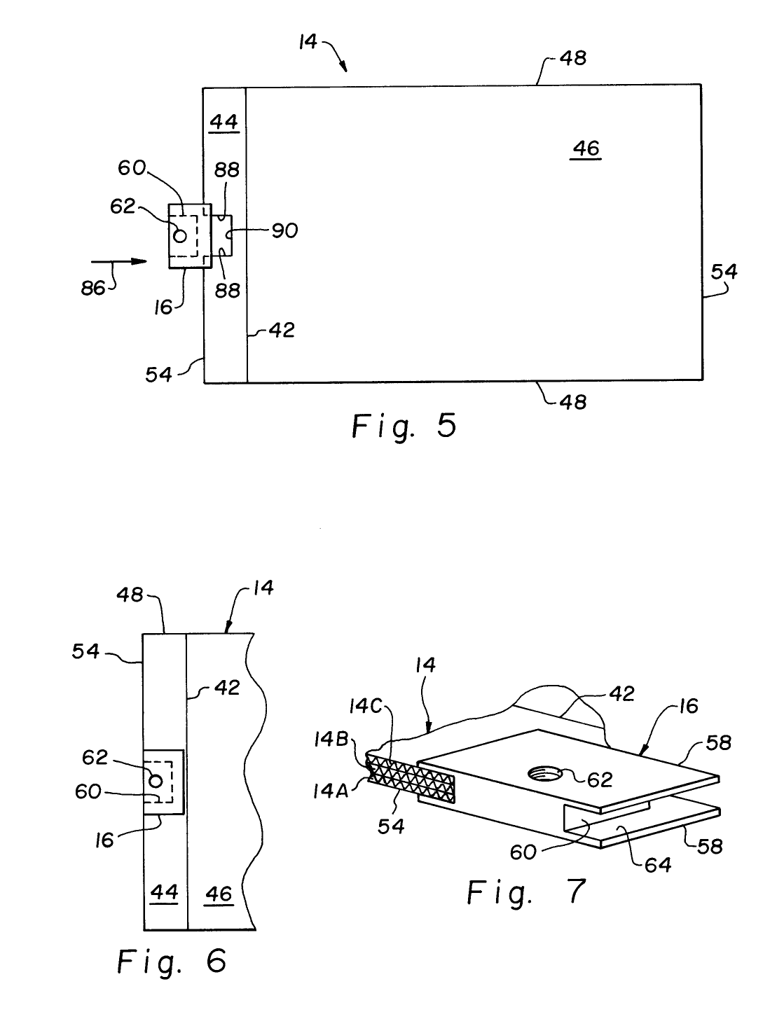

FIGS. 5 and 6 show a top view of bed 14 (that portion of bed 14 which opposes bottom wall 26). Thus, FIGS. 5 and 6 also show, more specifically, top layer 14C of bed 14. This top layer 14C of bed 14, however, is representative of the other layers 14A, 14B (below this top layer 14C), since each layer 14A, 14B, and 14C is substantially identical relative to one another.

Cardboard bed 14 includes a scored line 42 which runs transversely across a width of cardboard bed 14 to define a first portion 44 and a second portion 46 of cardboard bed 14. Stated another way, scored line 42 runs from one longitudinal edge 48 of cardboard bed 14 to the opposing longitudinal edge 48 of cardboard bed 14. Scored line 42 can be formed, for example, by a machine when the respective layers of cardboard bed 14 are cut to size. Scored line 42 allows cardboard bed 14 to more easily bend along scored line 42 and thus forms a bending line 42. In the first position 34, first portion 44 and second portion 46 are oriented substantially in the same plane 50; FIG. 4 shows plane 50 as a straight line (broken line extending from each end of bed 14 in FIG. 4), it being understood that plane 50 also extends perpendicular to the page of FIG. 4. Cardboard bed 14 is configured for being partially lifted off of bottom wall 26 using lifting device 18 (which is attached to cardboard shell 12) and thereby for bending cardboard bed 14 along scored line 42 such that, in the second position 36, first portion 44 remains substantially horizontal and substantially parallel relative to bottom wall 26 while second portion 46 forms an inclined angle 84 relative to bottom wall 26. Bed 14 bends along scored line 42 either under its own weight and/or only under weight added to second portion 46 of bed 14 (for example, due to the weight of body 20). Each layer 14A, 14B, 14C of bed 14 includes respectively a scored line 42 and thus also respective first and second portions 44, 46 such that each of the scored lines 42 of layers 14A-14C together form the scored line 42 of bed 14 and together layers 14A-14C form first and second portions 44, 46 of bed 14. The scored lines 42 of layers 14A-14C are substantially in line with one another, as shown by line 52 in FIG. 4. Each of the scored lines 42 of layers 14A-14C can be formed on the underside of each layer 14A-14C (the side of each layer 14A-14C which faces bottom wall 26) to allow second portion 46 of each layer 14A-14C to bend downwardly as first portion 44 of each layer 14A-14C is lifted upwardly. Alternatively, the scored lines 42 of layers 14A-14C can be formed on each side of each layer 14A-14C (on the sides facing toward and away from bottom wall 26), according to however the application dictates.

Cardboard bed 14 further includes two opposing longitudinal edges 48 and two opposing transverse edges 54. Cardboard bed 14 includes an edge 54 with a cutout 56 in first portion 44 of cardboard bed 14; more specifically, first portion 44 includes one transverse edge 54, this transverse edge 54 including cutout 56 (if more than one lifting device 18 is used, then cardboard bed 14 can include additional cutouts 56 along any of its edges 48, 54 to accommodate the additional lifting devices 18). Cutout 56 can be formed by removing a portion of cardboard bed 14 (for example, by cutting that portion of cardboard out of cardboard bed 14). Cutout 56 can have generally a U-shape which accommodates clamp 16. Cutout 56 has parallel edges 88 and an edge 90 extending between edges 88. With a plurality of layers 14A-14C, each layer 14A-14C then has opposing longitudinal edges 48 and opposing transverse edges 54 as described above. Further, first portion 44 of each layer 14A-14C includes a transverse edge 54 which includes a cutout 56. The cutouts 56 of each layer 14A-14C together form the cutout 56 of bed 14. Stated another way, the plurality of layers 14A-14C together form cutout 56, as shown in FIGS. 7 and 8. In one embodiment of cardboard bed 14 (and thus provided merely by way of example and without limitation), bed 14 can have the following characteristics: a grain or corrugation direction which is horizontal (in other words, the corrugation direction can run in the transverse direction of bed 14 and thus between longitudinal edges 48, perpendicular to longitudinal edges 48 and parallel to transverse edges 54); an area of 777 square inches; a blank width of 21 and ¾ inches (the width running from one longitudinal edge 48 to the other longitudinal edge 48); a blank height/length of 36 inches (the height/length runs from one transverse edge 54 to the other transverse edge 54); waste on blank is 0.77; Len. cutting rule is 122+⅝ (used for die making); Len. other rule is 21+¾ (used for die making); a paper grade of 48 ECT; the distance between transverse edge 54 and scored line 42 is 3 and ⅛ inches; the depth of cutout 56 running from transverse edge 54 to edge 90 is 2 inches; the distance between edges 88 of cutout 56 is 3 inches; the distance from longitudinal edge 48 to the nearest edge 88 of cutout 56 is 9 and ⅜ inches. Alternatively, each layer 14A-14C can have a corrugation direction running in the longitudinal direction of bed 14 (that is, running between transverse edges 54). Each layer 14A-14C can include two sub-layers. As such, each sub-layer includes a bottom papersheet (such as a flat liner), a bottom corrugation layer having a corrugation direction (the direction in which the flutes or folds run) running in the longitudinal direction of the bed 14 on top of the bottom papersheet, an intermediate papersheet (such as a flat liner) lying on top of the bottom corrugation layer, a top corrugation layer running in the longitudinal direction of the bed on top of the intermediate papersheet, and a top papersheet (such as a flat liner) lying on top of the top corrugation layer. Alternatively, each layer can have a corrugation direction running in the transverse direction of bed 14 and also have two sub-layers as described above (but with the corrugation direction of each sub-layer running in the transverse direction of bed 14). Alternatively, bottom layer 14A can have a corrugation direction running in the longitudinal direction of bed 14, middle layer 14B having a corrugation direction running in the transverse direction of bed 14, and top layer 14C having a corrugation direction running in the longitudinal direction of bed 14; each layer 14A-14C can include two-sub-layers as described above (but with corrugation directions as described for this embodiment). Alternatively, bed 14 can include any number of layers depending upon the application. Further, the corrugation direction of each layer of bed 14 can run in any direction depending upon the application and the corrugation direction of the layers can be the same or can vary amongst the layers of bed 14 in any conceivable combination, depending upon the application. Further, while each layer of bed 14 has been described as having two sub-layers, it is understood that each layer of bed 14 may have only one sub-layer or may have two or more sub-layers; further, the number of sub-layers can be the same or can vary amongst the layers of bed 14, and the corrugation direction of each layer of bed 14 can run in any direction depending upon the application and the corrugation direction of the layers can be the same or can vary amongst the layers of bed 14 in any conceivable combination, depending upon the application. It is noted that FIGS. 7 and 8 specifically show the corrugation direction running in the longitudinal direction of bed 14 for each layer 14A-14C. FIGS. 7 and 8 also show each layer 14A-14C having only a single sub-layer, but it is understood that the layers 14A-14C are shown schematically; thus, each layer 14A-14C can include two sub-layers as described above.

Clamp 16 is attached to both cardboard bed 14 and to lifting device 18. More specifically, clamp 16 matingly receives and is thereby attached to cutout 56; stated another way, cutout 56 is matingly received by and thereby attached to clamp 16. When clamp 16 is attached to cutout 56, scored line 42 (more specifically, each scored line 42 of each layer 14A-14C) runs adjacent to clamp 16. Stated another way, scored line 42 (which can be referred to as a score relief) is positioned near clamp 16 to allow cardboard bed 14 to crease and thus to provide relief as body 20 is lifted upwardly using lifting device 18. Scored line 42 can be positioned exactly along the end of clamp 16 or, alternatively, slightly away from the end of clamp 16 (as shown in FIG. 6). Clamp 16 is made of plastic; more specifically, clamp can be made of polyvinyl chloride (also known as PVC). Either upon removal of body 20 or along with body 20, clamp 16 advantageously can be burned along with cardboard casket 12 and cardboard bed 14. Clamp 16 is rigid and can be insert molded and formed as a single piece. Alternatively, clamp 16 can be formed of a plurality of pieces (i.e., two side walls 58 and a plug 60) which are attached to one another.

Clamp 16 includes opposing side walls 58 and a plug 60 therebetween. Each side wall 58 can be formed substantially as a square or rectangle. Plug 60 can have a general square or rectangular box shape. Plug 60 includes a threaded through-bore 62. Side walls 58 and plug together define a U-shaped channel 64 which matingly and slidably receives cutout 56 when clamp 16 is slid onto cutout 56 of cardboard bed 14. FIG. 5 shows clamp 16 being slid onto cutout 56 in the direction of arrow 86. According to one embodiment of the present invention, clamp 16 and cardboard bed 14 are glued together (i.e., by gluing side walls 58 to the bottom surface (the surface facing toward bottom wall 26) of layer 14A, and/or to the top surface (the surface facing away from bottom wall 26) of layer 14C), and/or by gluing plug 60 to transverse edge 54 of bed formed by cutout 56). According to another embodiment of the present invention, clamp 16 and cardboard bed 14 are not glued together. Clamp 16 is thus attached to layers 14A-14C and is thereby attached to bed 14. Layers 14A-14C can be glued together before attaching layers 14A-14C to clamp 16.

Lifting device 18 includes a guide block 66, a threaded rod 38, and a crank 68. Guide block 66 is mounted to, and thereby attached to, container 12, such as casket shell 12. Guide block 66 can be glued to an interior face of end wall 28 of cardboard casket 12 and/or to a top edge of the same end wall 28. FIGS. 1, 2, and 3 show guide block 66 as a single block; guide block 66 can be, for example, a wooden block having a general L-shaped configuration when viewed from the side (for example, as shown in FIG. 4). Alternatively, guide block 66 can be a plurality of blocks, such as a plurality of wooden blocks. As shown in FIGS. 1-3, guide block 66 can have a cross-sectional shape running from top to bottom which is generally trapezoidal, the cross-section being taken along a plane which is substantially parallel to bottom wall 26; as such, the front face of guide block 66 and the rear face of guide block 66 can be substantially parallel to one another but the sides running between the front and rear faces of guide block 66 form an acute angle with, for instance, the rear face, that angle being the same such that the rear face has a greater transverse extent than the front face and the sides run in a direction generally toward one another running from the rear face to the front face. Alternatively, guide block 66 can have a cross-sectional shape running from top to bottom which is generally square or rectangular, the cross-section being taken along a plane which is substantially parallel to bottom wall 26; thus, guide block 66 can have a front face (which faces body 20) and a rear face (the face opposing the front face) which have substantially the same transverse extent (running parallel to transverse edge 54). Guide block 66 includes a through-hole 72 which receives threaded rod 38. Guide block 66 serves to support threaded rod 38 in at least a substantially vertical position. Threaded rod 38 is held loosely in, and thereby can rotate freely within, the through-hole 72 of guide block 66. Threaded rod 38 includes a head 74 and a threaded section 40. Head 74 includes a blind hole 78 in the top thereof for matingly receiving a hexagon-shaped male portion 80 (which can be referred to as a hex-key 80) of crank 68, which is used by the operator of lifting device 18 to rotate rod 38. Rod 38 can be made of plastic, such as ultra-high molecular weight polyethylene. Rod 38 can be insert molded, for example, as a single piece. As a plastic piece, rod 38 can optionally remain with cardboard casket 12 and be burned along with cardboard casket 12, clamp 16, and bed 14 during cremation of body 20 or can be withdrawn from through-hole 72 before any burning of cardboard casket 12 and the contents therein. Alternatively, rod 38 can be a metallic structure and can be withdrawn from the through-hole 72 of guide block 66 before any burning of cardboard casket 12 and the contents therein. Crank 68 can be a conventional device. For instance, crank 68 can include a hex-key 80 (which can also be referred to as a bolt and can be metallic) and a handle 82 (which is grasped and turned by an operator) which is detachable from hex-key 80. Rod 38 is threadably received by and thereby releasably attached to through-bore 62 of clamp 16. Lifting device 18 is configured for selectively raising and lowering clamp 16 attached to cardboard bed 14 as threaded rod 38 is rotated in through-bore 62 using crank 68.

In use, according to the embodiment of the invention using three cardboard layers 14A-14C to form cardboard bed 14, a substantially identical cutout 56 is cut out of the same transverse edge 54 of each layer 14A-14C. The layers 14A-14C are laminated on top of one another such that the cutouts 56 of each layer 14A-14C line up with one another to form cutout 56 of cardboard bed 14. Adjacent layers 14A-14C are adhered to one another. The adhering of adjacent layers 14A-14C can occur before clamp 16 is slid onto cutout 56. Each layer 14A-14C is scored in substantially the same place on the like layers 14A-14C. Clamp 16 is attached to cutout 56 using glue, particularly glue between side walls 58 of clamp 16 and outwardly facing sides of bed 14. Bed 14 is then inserted into shell 12 and laid on bottom wall 26 of cardboard casket 12. Guide block 66 can then be glued to an end wall 28 of cardboard casket 12, such as to the interior face of end wall 28 and/or to the top of end wall 28 (the top of end wall 28 being relative to end wall 28 being in an upstanding position). Layers 14A, 14B, and 14C of bed 14 can be adhered to one another using a hot melt glue, the hot melt glue setting when it cools back to room temperature. Bed 14 can be adhered to clamp 16 using a hot melt glue and/or a cold set glue. Guide block 66 can be adhered to container 12 using a hot melt glue and/or a cold set glue. The hot melt glue and the cold set glue at times can be applied together. The hot melt glue can be Bostwick PHC9254. The cold set glue can be Bostwick WB-3706-EN-001. Rod 38 can be inserted through through-hole 72 of guide block 66. Rod 38 can be directed into through-hole 62 of clamp 16. Crank 68 can be attached to head 74 of rod 38. Upon rotating rod 38 using crank 68, rod 38 becomes threadably connected to through-hole 62 of clamp 16. Depending upon the length of rod 38, rod 38 can be rotated to such a degree that the tip (opposite head 74) of rod 38 touches bottom wall 26 of cardboard casket 12 and that clamp 16 ascends along the threaded portion 40 of rod 38. In causing clamp 16 to ascend along rod 38, clamp 16 causes first portion 44 (that is, first portion 44 of each layer 14A-14C) of bed 14 to rise as well. Bed 14 then bends along scored line 42 (that is, the scored line 42 of each layer 14A-14C) and second portion 46 (that is, the second portion 46 of each layer 14A-14C) forms an angle with bottom wall 26 as first portion 44 ascends. The end of bed 14 opposite clamp 16 remains on bottom wall 26. The operator of crank 68 can selectively stop bed 14 along threaded portion 40 of rod 38; in this manner, bed 14 stops in second position 36. As bed 14 is tilted in this manner, body 20 lying on bed 14 is caused to at least partially rise along with bed 14 such that body 20—in particular, the face of body 20 which is near clamp 16—is more easily viewable in cardboard casket 12. When the viewing of body 20 is finished, the operator of crank 68 can reattach crank 68 (more specifically, hex key 80) to rod 38 and rotate rod 38 in the opposite direction so as to lower bed 14 (and thus also body 20) back onto bottom wall 26 of cardboard casket 12 (that is, to the first position 34). This rotation can continue until rod 38 exits from through-hole 62 of clamp 16. Then, crank 68 and rod 38 can be removed from cardboard casket 12 altogether so that, for example, body 20, cardboard casket 12, clamp 16, guide block 66, and rod 38 (if so desired) can be burned during cremation (crank 68 and rod 38 can then be reused with another casket 12); alternatively, rod 38 may remain with casket 12 and be burned therewith.

The casket system 10 can include plastic liners (not shown) (so as to collect bodily fluids) in cardboard casket 12; such a plastic liner can be placed between bottom wall 26 and bed 14 (in this sense, bed 14 is still positionable on bottom wall 26 within the meaning of the present invention). Further, the casket system 10 can also include upholstery (not shown) over exterior casket 24 and/or cardboard casket 12 to render the casket system 10 more aesthetically pleasing. Further, in an alternative embodiment of the present invention (not shown), a plurality of lifting devices 18, and additional corresponding cutouts 56 and clamps 16, can be provided, such as to be able to completely lift bed 14 off of bottom wall 26.

The present invention further provides a method of lifting body 20 associated with a casket system 10, the method including: providing container 12 holding body 20, container 12 including bottom wall 26; positioning cardboard bed 14 within container 12, body 20 lying at least partially on cardboard bed 14; positioning selectively cardboard bed 14 between a first position 34 and a second position 36 within container 12, first position 34 being oriented substantially horizontally and substantially parallel relative to bottom wall 26, second position 36 being one of a plurality of selectively inclined positions 36A, 36B, . . . 36x relative to bottom wall 26. Container 12 can be cardboard casket 12 formed as a tub 12. The method can further include attaching lifting device 18 to cardboard casket 12, cardboard bed 14 including scored line 42 which runs transversely across the width of cardboard bed 14 to define first portion 44 and second portion 46 of cardboard bed 14, in first position 34 first portion 44 and second portion 46 being oriented substantially in the same plane 50, the method further including lifting, partially, cardboard bed 14 off of bottom wall 26 using lifting device 18 and thereby bending cardboard bed 14 along scored line 42 such that, in second position 36, first portion 44 remains substantially horizontal and substantially parallel relative to bottom wall 26 while second portion 46 forms an inclined angle relative 84 to bottom wall 26. The method can further include attaching a clamp 16 to lifting device 18, cardboard bed 14 including an edge 54 with a cutout 56 in first portion 44 of cardboard bed 14, the method further including receiving matingly cutout 56 by, and thereby attaching cutout 56 to, clamp 16, scored line 42 running adjacent clamp 16. Clamp 16 is rigid and includes opposing side walls 58 and a plug 60 therebetween, plug 60 including a threaded through-bore 62, side walls 58 and plug 60 together defining a U-shaped channel 64, the method further including receiving, matingly and slidably, cutout 56 by U-shaped channel 64. Lifting device 18 includes a threaded rod 38 which is threadably received by and thereby releasably attached to through-bore 62, the method further including using lifting device 18 to selectively raise and lower clamp 16 attached to cardboard bed 14 as threaded rod 38 is rotated in through-bore 62. Cardboard bed 14 can include a plurality of layers 14A, 14B, 14C attached respectively to one another, the plurality of layers 14A-14C together forming cutout 56.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A casket system, comprising:
a container configured for holding a body, said container including a bottom wall; and
a cardboard bed positioned within said container and configured for being that on which said body at least partially lies, said cardboard bed being selectively positionable between a first position and a second position within said container, said first position being oriented substantially horizontally and substantially parallel relative to said bottom wall, said second position being one of a plurality of selectively inclined positions relative to said bottom wall.

2. The casket system of claim 1, wherein said container is a cardboard casket formed as a tub.

3. The casket system of claim 2, further including a lifting device attached to said cardboard casket, said cardboard bed including a scored line which runs transversely across a width of said cardboard bed to define a first portion and a second portion of said cardboard bed, in said first position said first portion and said second portion being oriented substantially in a same plane, said cardboard bed being configured for being partially lifted off of said bottom wall using said lifting device and thereby for bending said cardboard bed along said scored line such that, in said second position, said first portion remains substantially horizontal and substantially parallel relative to said bottom wall while said second portion forms an inclined angle relative to said bottom wall.

4. The casket system of claim 3, further including a clamp attached to said lifting device, said cardboard bed including an edge with a cutout in said first portion of said cardboard bed, said cutout being matingly received by and thereby attached to said clamp, said scored line running adjacent said clamp, said clamp being rigid and including opposing side walls and a plug therebetween, said plug including a threaded through-bore, said side walls and said plug together defining a U-shaped channel which matingly and slidably receives said cutout.

5. The casket system of claim 4, wherein said lifting device includes a threaded rod which is threadably received by and thereby releasably attached to said through-bore, said lifting device configured for selectively raising and lowering said clamp attached to said cardboard bed as said threaded rod is rotated in said through-bore.

6. The casket system of claim 4, wherein said cardboard bed includes a plurality of layers attached respectively to one another, said plurality of layers together forming said cutout.

7. A casket system, comprising:
a container configured for holding a body, said container including a bottom wall;
a cardboard bed positioned within said container and configured for being that on which said body at least partially lies and for being at least partially lifted off of said bottom wall while said cardboard bed remains in said container.

8. The casket system of claim 7, wherein said container is a cardboard casket formed as a tub.

9. The casket system of claim 8, wherein said cardboard bed is selectively positionable between a first position and a second position within said cardboard shell, said first position being oriented substantially horizontally and substantially parallel relative to said bottom wall, said second position being one of a plurality of selectively inclined positions relative to said bottom wall, the casket system further including a lifting device attached to said cardboard casket, said cardboard bed including a scored line which runs transversely across a width of said cardboard bed to define a first portion and a second portion of said cardboard bed, in said first position said first portion and said second portion being oriented substantially in a same plane, said cardboard bed being configured for being partially lifted off of said bottom wall using said lifting device and thereby for bending said cardboard bed along said scored line such that, in said second position, said first portion remains substantially horizontal and substantially parallel relative to said bottom wall while said second portion forms an inclined angle relative to said bottom wall.

10. The casket system of claim 9, further including a clamp attached to said lifting device, said cardboard bed including an edge with a cutout in said first portion of said cardboard bed, said cutout being matingly received by and thereby attached to said clamp, said scored line running adjacent said clamp, said clamp being rigid and including opposing side walls and a plug therebetween, said plug including a threaded through-bore, said side walls and said plug together defining a U-shaped channel which matingly and slidably receives said cutout.

11. The casket system of claim 10, wherein said lifting device includes a threaded rod which is threadably received by and thereby releasably attached to said through-bore, said lifting device configured for selectively raising and lowering said clamp attached to said cardboard bed as said threaded rod is rotated in said through-bore.

12. The casket system of claim 10, wherein said cardboard bed includes a plurality of layers attached respectively to one another, said plurality of layers together forming said cutout.

13. A method of lifting a body associated with a casket system, said method comprising:
providing a container holding the body, said container including a bottom wall;
positioning a cardboard bed within said container, the body lying at least partially on said cardboard bed;
positioning selectively said cardboard bed between a first position and a second position within said container, said first position being oriented substantially horizontally and substantially parallel relative to said bottom wall, said second position being one of a plurality of selectively inclined positions relative to said bottom wall.

14. The method of claim 13, wherein said container is a cardboard casket formed as a tub.

15. The method of claim 14, further including attaching a lifting device to said cardboard casket, said cardboard bed including a scored line which runs transversely across a width of said cardboard bed to define a first portion and a second portion of said cardboard bed, in said first position said first portion and said second portion being oriented substantially in a same plane, the method further including lifting, partially, said cardboard bed off of said bottom wall using said lifting device and thereby bending said cardboard bed along said scored line such that, in said second position, said first portion remains substantially horizontal and substantially parallel relative to said bottom wall while said second portion forms an inclined angle relative to said bottom wall.

16. The method of claim 15, further including attaching a clamp to said lifting device, said cardboard bed including an edge with a cutout in said first portion of said cardboard bed, the method further including receiving matingly said cutout by, and thereby attaching said cutout to, said clamp, said scored line running adjacent said clamp, clamp being rigid and including opposing side walls and a plug therebetween, said plug including a threaded through-bore, said side walls and said plug together defining a U-shaped channel, the method further including receiving, matingly and slidably, said cutout by said U-shaped channel.

17. The method of claim 16, wherein said lifting device includes a threaded rod which is threadably received by and thereby releasably attached to said through-bore, the method further including using said lifting device to selectively raise and lower said clamp attached to said cardboard bed as said threaded rod is rotated in said through-bore.

18. The method of claim 16, wherein said cardboard bed includes a plurality of layers attached respectively to one another, said plurality of layers together forming said cutout.
